(19) United States
(12) Patent Application Publication
(10) Pub. No.: US 2007/0155883 A1
(43) Pub. Date: Jul. 5, 2007

(54) Crosslinked flame-retardant resin composition, and an insulated wire and a wiring harness using the same

(76) Inventors: Masashi Sato, Mie (JP); Shinichi Matsumoto, Mie (JP)

Correspondence Address: OLIFF & BERRIDGE, PLC, P.O. BOX 19928, ALEXANDRIA, VA, 22320, US

(21) Appl. No.: 10/581,994

(22) PCT Filed: Dec. 2, 2004
(86) PCT No.: PCT/JP04/18343

§ 371 Date: Jun. 16, 2006

(30) Foreign Application Priority Data
Dec. 15, 2003 (JP) 2003-416023

(51) Int. Cl. C08K 3/30

(52) U.S. Cl. 524/420

(57) ABSTRACT

To provide a crosslinked flame-retardant resin composition excellent in flame retardancy, wear resistance, flexibility, workability and compatibility with other materials, and an insulated wire and a wiring harness using the same. The composition contains 100 part weight of a resin ingredient containing (A) polyethylene of which MFR is 5 g/10 min. or less and density is 0.90 g/cm³ or more and (B) at least one polymer selected from (B1) alpha-olefin (co)polymer, (B2) ethylene-vinylester copolymer, (B3) ethylene-alpha, beta-unsaturated carboxylic acid alkyl ester copolymer, and (B4) a stylene thermoplastic elastomer, 30-250 part weight of (C) metallic hydrate and 1-20 part weight of (D) a zinc compound, in which the content of (A) the polyethylene is 30-90 wt % and the content of (B) the polymer is 70-10 wt %, and the (B) ingredient is modified by acid and/or 0.3-10 part weight of (E) an organo-functional coupling agent is further contained. This composition is used for an insulated wire and a wiring harness.

### TECHNICAL FIELD

The present invention relates to a crosslinked flame-retardant resin composition, and an insulated wire and a wiring harness using the same, and more specifically relates to a crosslinked flame-retardant resin composition suitable for an insulated covering material for an insulated wire used in parts for a car such as an automobile, electric/electronic equipment and the like, and an insulated wire and a wiring harness using the same.

### BACKGROUND ART

Conventionally, for an insulated covering material for an insulated wire used in carrying out wiring of parts for a car such as an automobile, electric/electronic equipment and the like, generally in wide use is a vinyl chloride resin excellent in flame retardancy, into which, according to a variety of required properties including mechanical properties such as wear resistance, flexibility, and workability, additives such as a plasticizer and a stabilizer are blended as appropriate and adjustments are made to types and blending amounts of the additives.

However, there is a problem that the vinyl chloride resin, having flame retardancy by itself, includes halogen elements in its molecular chains, so that it emits harmful halogenous gas into the atmosphere in case of car fire or at the time of combustion for disposing of electric/electronic equipment by incineration, causing environmental pollution.

Under the circumstances, developed these days has been a so-called non-halogenous flame-retardant resin composition, which is prepared by using a polyolefin resin such as polyethylene and polypropylene as its base resin and adding metallic hydrate such as magnesium hydroxide as a flame retardant; however, there is a disadvantage that mechanical properties such as tensile strength and wear resistance, flexibility, and workability degrade since the non-halogenous flame-retardant resin composition requires a large amount of metallic hydrate to be added thereto as the flame retardant.

Thus, in order to overcome such a disadvantage, for example, Japanese Patent Gazette No. 3280105 discloses a non-halogenous crosslinked flame-retardant resin composition which is prepared by adding metallic hydrate and a cross-linking auxiliary agent to a resin ingredient containing polyethylene or an alpha-olefin copolymer and an ethylene copolymer or a rubber, and further containing a specific functional group therein.

However, the following problems arise even if the conventionally-known crosslinked flame-retardant resin composition is used as the insulated covering material for the insulated wire. In an automobile and the like, it is generally often the case that a plurality of insulated wires are tied into a wire bundle, around which a protective material in various shapes such as a tape, tube and sheet is wound to be utilized as a wiring harness.

At this time, as the insulated wires making up the wiring harness, not only non-halogenous insulated wires in which non-halogenous flame-retardant resin compositions are used as insulated covering materials are used, but also vinyl chloride insulated wires and the like in which vinyl chloride resin compositions such as polyvinyl chloride are used as insulated covering materials are abundantly used, empirically.

Therefore, mixed use of the non-halogenous insulated wires and the vinyl chloride insulated wires is difficult to completely avoid. Under these circumstances, it turned out that if the non-halogenous insulated wires are used in contact with the vinyl chloride insulated wires and the like, there arises a problem of remarkably deteriorating the insulated covering material for the non-halogenous insulated wires in the wire bundle to degrade heat resistance (there arises a problem with compatibility with other materials).

Further, since the vinyl chloride resin composition and the like are usually used frequently as a base material for the wiring-harness protective material wound around the wire bundle, it turned out that a problem with compatibility also arises if the non-halogenous insulated wire is used in contact with the vinyl-chloride wiring-harness protective material and the like.

Though a detailed mechanism of the sources of these problems is not found yet, the problems are assumed to arise because when the vinyl chloride insulated wire, the vinyl-chloride wiring-harness protective material or the like comes into contact with the non-halogenous insulated wire, an antioxidant in the insulated covering material composed of the non-halogenous flame-retardant resin composition is remarkably consumed, or the antioxidant itself makes a transition into the vinyl chloride insulated wire, the vinyl-chloride wiring-harness protective material or the like. At any rate, there is a need to immediately solve problems concerning deterioration of those kinds.

Consequently, the present invention has been made in view of the above circumstances and has an object to overcome the above problems and to provide a crosslinked flame-retardant resin composition which possesses sufficient flame retardancy, mechanical properties such as wear resistance, flexibility and workability, and is excellent in compatibility with other materials, especially a vinyl-chloride resin material.

In addition, another object of the invention is to provide a non-halogenous insulated wire using the above-described crosslinked flame-retardant resin composition as an insulated covering material, and a wiring harness including the non-halogenous insulated wire.

### DISCLOSURE OF THE INVENTION

To achieve the objects and in accordance with the purpose of the present invention, as embodied and broadly described herein, a crosslinked flame-retardant resin composition consistent with the present invention is a composition which contains 100 part weight of a resin ingredient containing (A) polyethylene of which a melt flow rate (MFR) is 5 g/10 min. or less and density is 0.90 g/cm³ or more and (B) at least one polymer selected from (B1) alpha-olefin (co)polymer, (B2) ethylene-vinylester copolymer, (B3) ethylene-alpha, beta-unsaturated carboxylic acid alkyl ester copolymer and (B4) a stylene thermoplastic elastomer, 30-250 part weight of (C) metallic hydrate, and 1-20 part weight of (D) a zinc compound, in which, in the resin ingredient, the content of (A) the polyethylene is 30-90 wt % and the content of (B) the polymer is 70-10 wt %, and at least one of (B) the polymer is modified by acid and/or 0.3-10 part weight of (E) an organo-functional coupling agent is further contained.

Here, (D) the zinc compound is preferably zinc sulfide.

Meanwhile, a non-halogenous insulated wire consistent with the present invention includes a conductor covered with the crosslinked flame-retardant resin composition as mentioned above.

At this time, the non-halogenous insulated wire is preferably cross-linked by radiation, peroxide, or a silane cross-linking agent.

In addition, a wiring harness consistent with the present invention includes a single wire bundle including only the non-halogenous insulated wires or a mixed wire bundle including at least the non-halogenous insulated wires and vinyl chloride insulated wires, and a wiring-harness protective material for covering the wire bundle, in which a non-halogenous resin composition, a vinyl chloride resin composition, or a halogenous resin composition other than the vinyl chloride resin composition is used as a base material.

The crosslinked flame-retardant resin composition consistent with the present invention is prepared by containing (C) the metallic hydrate and (D) the zinc compound by specific amounts in the resin ingredient containing at the specific blending ratio (A) the polyethylene specified by the specific melt flow rate (MFR) and the specific density and (B) at least one polymer selected from (B1) the alpha-olefin (co)polymer, (B2) the ethylene-vinylester copolymer, (B3) the ethylene-alpha, beta-unsaturated carboxylic acid alkyl ester copolymer and (B4) the stylene thermoplastic elastomer, and in the composition, the (B) ingredient is modified by acid and/or the specific amount of (E) the organo-functional coupling agent is further contained Therefore, it is made excellent in compatibility with other materials, especially a vinyl chloride resin material, while maintaining sufficient flame retardancy, mechanical properties such as wear resistance, flexibility, and workability.

Further, according to the non-halogenous insulated wire consistent with the present invention in which the above-described crosslinked flame-retardant resin composition is used as an insulated covering material and the wiring harness consistent with the present invention in which the non-halogenous insulated wire is included in its wire bundle, heat resistance is sufficiently delivered over a long period of time without remarkably deteriorating the insulated covering material even in the case of using the non-halogenous insulated wire in contact with the vinyl chloride insulated wire in the wire bundle or in contact with the vinyl-chloride wiring-harness protective material for covering the wire bundle or the halogenous wiring-harness protective material other than the vinyl-chloride wiring-harness protective material.

Therefore, the use of the non-halogenous insulated wire and the wiring harness consistent with the present invention in an automobile and the like may ensure high reliability over a long period of time. In addition, the excellent compatibility of the non-halogenous insulated wire and the wiring harness with other materials improves flexibility in its design and routing.

### BEST MODE FOR CARRYING OUT THE INVENTION

A detailed description of one preferred embodiment of the present invention will now be given. A crosslinked flame-retardant resin composition consistent with the present invention is a composition which contains 100 part weight of a resin ingredient containing (A) polyethylene of which a melt flow rate (MFR) is 5 g/10 min. or less and density is 0.90 g/cm³ or more and (B) at least one polymer selected from (B1) alpha-olefin (co)polymer, (B2) ethylene-vinylester copolymer, (B3) ethylene-alpha, beta-unsaturated carboxylic acid alkyl ester copolymer and (B4) a stylene thermoplastic elastomer, 30-250 part weight of (C) metallic hydrate, and 1-20 part weight of (D) a zinc compound, in which, in the resin ingredient, the content of (A) the polyethylene is 30-90 wt % and the content of (B) the polymer is 70-10 wt %, and at least one of (B) the polymer is modified by acid and/or (E) an organo-functional coupling agent is further contained. Firstly, the ingredients of the crosslinked flame-retardant resin composition consistent with the present invention will be respectively described.

The (A) ingredient referred to in the present invention is polyethylene of which the melt flow rate (MFR) is 5 g/10 min. or less and the density is 0.90 g/cm³ or more. Specifically named are high density polyethylene (HDPE), medium density polyethylene (MDPE), low density polyethylene (LDPE), linear low density polyethylene (LLDPE), and the like, of which the melt flow rate (MFR) is 5 g/10 min. or less and the density is 0.90 g/cm³ or more. Among them, high density polyethylene (HDPE) and linear low density polyethylene (LLDPE) are preferable. Besides, they may be employed by one sort alone or more than one sort in combination.

Here, it is desirable that the melt flow rate (MFR) is 5 g/10 min. or less, preferably 3 g/10 min. or less, more preferably 2 g/10 min. or less because a tendency that compatibility and the like are not satisfied is demonstrated if the melt flow rate (MFR) is more than 5 g/10 min. Incidentally, the melt flow rate (MFR) is a value measured in accordance with JIS K 6760 or an equivalent standard to JIS K 6760.

The (B) ingredient referred to in the present invention is at least one polymer selected from (B1) the alpha-olefin (co)polymer, (B2) the ethylene-vinylester copolymer, (B3) the ethylene-alpha, beta-unsaturated carboxylic acid alkyl ester copolymer and (B4) the stylene thermoplastic elastomer.

(B1) The alpha-olefin (co)polymer referred to in the present invention is homopolymer or copolymer of ethylene, propylene, alpha-olefin such as 1-butene, 4-methyl-1-pentene, 1-hexene, 1-heptene, 1-octane, 1-nonene, 1-decene, 1-undecene, 1-dodecene, 1-tridecene, 1-tetradecene, 1-pentadecene, 1-hexadecene, 1-heptadecene, 1-nonadecene, 1-eicosene, 9-methyl-1-decene, 11-methyl-l-dodecene and 12-ethyl-1-tetradecene, or copolymer or mixtures of ethylene and the above-described alpha-olefin.

Incidentally, in the case of using homopolymer of ethylene, i.e., polyethylene, its melt flow rate (MFR) and density are not particularly specified in contrast to the polyethylene as the (A) ingredient, and high density polyethylene (HDPE), medium density polyethylene (MDPE), low density polyethylene (LDPE), linear low density polyethylene (LLDPE), very low density polyethylene (VLDPE), and the like, which have an arbitrary melt flow rate (MFR) and arbitrary density may be used.

Among them, high density polyethylene (HDPE), linear low density polyethylene (LLDPE), very low density polyethylene (VLDPE), and ethylene-propylene copolymer (EPM) are preferable.

For vinylester monomer used for (B2) the ethylene-vinylester copolymer in the present invention, named are vinyl acetate, vinyl propionate, vinyl caproate, vinyl caprylate, vinyl laurate, vinyl stearate, vinyl trifluoroacetate, and the like. Among them, ethylene-vinyl acetate copolymer (EVA) is preferable. Besides, they may be employed by one sort alone or more than one sort in combination.

For alpha, beta-unsaturated carboxylic acid alkyl ester monomer used for (B3) the ethylene-alpha, beta-unsaturated carboxylic acid alkyl ester copolymer in the present invention, named are methyl acrylate, ethyl acrylate, butyl acrylate, methyl methacrylate, ethyl methacrylate, and the like. Among them, ethylene-ethyl acrylate copolymer (EEA) and ethylene-butyl acrylate copolymer (EBA) are preferable. Besides, they may be employed by one sort alone or more than one sort in combination.

For (B4) the stylene thermoplastic elastomer in the present invention, named are block copolymer of styrene and butadiene (or styrene and ethylene-propylene), a hydrogenerated or partially-hydrogenerated derivative of the block copolymer, and the like. Specifically named are styrene-ethylene-butylene-styrene block copolymer (SEBS), styrene-ethylene-propylene-styrene block copolymer (SEPS), and the like. Among them, styrene-ethylene-butylene-styrene block copolymer (SEBS) and styrene-ethylene-propylene-styrene block copolymer (SEPS) are preferable. Besides, they may be employed by one sort alone or more than one sort in combination.

In the case of modifying at least one of (B) the polymer by acid, unsaturated carboxylic acid or its derivative, and the like may be used. Specifically, named as the unsaturated carboxylic acid are maleic acid, fumaric acid and the like, and named as the derivative of the unsaturated carboxylic acid are maleic anhydride, monoester of maleic acid, diester of maleic acid, and the like. Among them, maleic acid and maleic anhydride are preferable. Besides, they may be employed by one sort alone or more than one sort in combination.

For a method of introducing acid into (B) the polymer, named are a graft method, a direct (copolymerization) method, and the like. In addition, it is desirable that an amount of acid for modification is 0.1-20 wt %, preferably 0.2-10 wt %, more preferably 0.2-5 wt % with respect to the polymer because wear resistance tends to lower if the amount of acid is less than 0.1 wt %, and molding workability tends to deteriorate if more than 20 wt %.

For (C) the metallic hydrate in the present invention, which is used as a flame retardant, specifically named are compounds having a hydroxyl group or crystalline water, such as magnesium hydroxide, aluminum hydroxide, zirconium hydroxide, hydrated magnesium silicate, hydrated aluminum silicate, basic magnesium carbonate and hydro talcite. Among them, magnesium hydroxide and aluminum hydroxide are preferable because they are highly effective in frame retardancy and heat resistance and is also cost effective. Besides, they may be employed by one sort alone or more than one sort in combination.

At this time, though the particle size of metallic hydrate used differs according to its type, it is desirable in the case of magnesium hydroxide, aluminum hydroxide and the like mentioned above that an average particle size (d₅₀) is within the range of 0.1-20 μm, preferably 0.2-10 μm, more preferably 0.3-5 μm. This is because in a case where the average particle size is smaller than 0.1 μm, secondary cohesion between particles occurs to demonstrate a tendency to degrade mechanical properties, and in a case where the average particle size is larger than 20 μm, mechanical properties are degraded to demonstrate a tendency to give rise to surface roughness and the like when used as an insulated covering material.

In addition, particle surfaces may be subjected to surface finishing using a finishing agent such as a coupling agent (silanes such as amino silanes, vinyl silanes, epoxy silanes and acryl silanes, titanates, or the like) and a fatty acid (stearic acid, oleic acid, or the like). Alternatively, instead of providing such surface finishing, integral blending (simultaneously adding the finishing agent as a compounding agent at the time of resin mixture), for example, may be performed, which is not specifically limited. Besides, the coupling agent may be employed by one sort alone or more than one sort in combination.

For (D) the zinc compound in the present invention, specifically named are zinc sulfide, zinc sulfate, zinc nitrate, zinc carbonate, and the like. Among them, zinc sulfide is preferable. Besides, they may be employed by one sort alone or more than one sort in combination.

For (E) the organo-functional coupling agent in the present invention, named are a coupling agent of vinyl silanes, acryl silanes, epoxy silanes and amino silanes, and the like. Among them, vinyl silanes and acryl silanes are preferable. Besides, they may be employed by one sort alone or more than one sort in combination.

In the present invention, the content of the (A) ingredient and that of the (B) ingredient with respect to 100 part weight of the resin ingredient containing the (A) and (B) ingredients are respectively within the range of 30-90 wt % and 70-10 wt %, preferably within the range of 40-90 wt % and 60-10 wt %, more preferably within the range of 50-80 wt % and 50-20 wt %.

This is because wear resistance and the like tend to degrade if the content of the (A) ingredient is less than 30 wt % and the content of the (B) ingredient is more than 70 wt %, and flexibility, workability and the like tend to degrade if the content of the (A) ingredient is more than 90 wt % and the content of the (B) ingredient is less than 10 wt %.

In the present invention, the content of (C) the metallic hydrate with respect to 100 part weight of the resin ingredient containing the (A) and (B) ingredients is 30-250 part weight, preferably 50-200 part weight, more preferably 60-180 part weight.

This is because flame retardancy and the like tend to degrade if the content of (C) the metallic hydrate is less than 30 part weight, and flexibility, workability and the like tend to degrade if more than 250 part weight.

In the present invention, in the case of further containing (E) the organo-functional coupling agent, its content with respect to 100 part weight of the resin ingredient containing the (A) and (B) ingredients is 0.3-10 part weight, preferably 0.4-8 part weight, more preferably 0.5-4 part weight.

This is because wear resistance is not improved if the content of (E) the organo-functional coupling agent is less than 0.3 part weight, and bleeding of the organo-functional coupling agent and the like occur and workability and the like tend to lower if more than 10 part weight.

In the above description, the respective ingredients in the present invention are described, and to the crosslinked flame-retardant resin composition consistent with the present invention, general additives may be added as appropriate if necessary, for example, a heat stabilizer (an antioxidant, an anti-aging agent and the like), a metal deactivator (a copper inhibitor and the like), lubricant (fatty acids, fatty amides, metal soaps, hydrocarbons (waxes), esters, silicones and the like), a light stabilizer, a nucleating agent, an antistatic agent, a coloring agent, a flame-retardant auxiliary agent (silicones, nitrogens, zinc borates and the like), a coupling agent (silanes, titanates and the like), a softening agent (process oil and the like), and across-linking auxiliary agent (multifunctional monomer and the like).

Incidentally, the crosslinked flame-retardant resin composition consistent with the present invention does not contain the cross-linking auxiliary agent as an essential ingredient for the reason that it is capable of crosslinking and satisfies frame retardancy, wear resistance, flexibility, workability, and compatibility even if the cross-linking auxiliary agent is not contained. However, in view of enhancing cross-linking properties, it is desirable that the cross-linking auxiliary agent is contained.

A production process of the above-described crosslinked flame-retardant resin composition consistent with the present invention is not particularly limited, and a known production process may be employed. For example, the (A) to (D) ingredients and as necessary the (E) ingredient or other additives are blended, and subsequently dry-blended through the use of a generally-used tumbler and the like or dispersed uniformly by melting and kneading through the use of a generally-used kneader such as a Banbury mixer, a pressure kneader, a kneading extruder, a twin-screw extruder and a roll, and the obtained composition or a molding made from the composition may be cross-linked by radiation, peroxide, or a silane cross-linking agent. Besides, they may be uniformly dispersed by melting and kneading through the use of the generally-used kneader so that the cross-linked composition may be obtained simultaneously with obtaining the composition or the molding made from the composition, which is not particularly limited.

Next, a detailed description is given to the effect of the crosslinked flame-retardant resin composition consistent with the present invention.

The composition is prepared by containing (C) the metallic hydrate and (D) the zinc compound by specific amounts in the resin ingredient containing at the specific blending ratio (A) the polyethylene with the specific melt flow rate (MFR) and the specific density and the (B) ingredient being at least one polymer selected from (B1) the alpha-olefin (co)polymer, (B2) the ethylene-vinylester copolymer, (B3) the ethylene-alpha, beta-unsaturated carboxylic acid alkyl ester copolymer and (B4) the stylene thermoplastic elastomer, and in the composition, the (B) ingredient is modified by acid and/or the specific amount of (E) the organo-functional coupling agent is further contained. Therefore, it is made excellent in compatibility with other materials, especially, a vinyl chloride resin material while maintaining sufficient flame retardancy, mechanical properties such as wear resistance, flexibility, and workability.

In particular, compatibility, one of the important properties of the composition, is exerted by using (A) the polyethylene specified by the specific melt flow rate (MFR) and the specific density and (D) the zinc compound, preferably zinc sulfide. If, for example, polypropylene which is also polyolefin is used instead of (A) the polyethylene, compatibility is not exerted at all or sufficient compatibility cannot be obtained.

Next, a description is given to a constitution of a non-halogenous insulated wire and a wiring harness consistent with the present invention.

The non-halogenous insulated wire consistent with the present invention is a wire in which the above-described crosslinked flame-retardant resin composition is used as a material for an insulated covering material. In constituting the non-halogenous insulated wire, a conductor may be directly covered with the insulated covering material, or another intermediate member such as a shielded conductor and another insulator may be interposed between the conductor and the insulated covering material.

In addition, the diameter, material properties and the like of the conductor are not limited in particular and may be determined appropriately as usage. The thickness of the insulated covering material is neither limited in particular and may be determined appropriately in consideration of the conductor diameter and the like.

As for a production process of the non-halogenous insulated wire, it may be produced by extrusion covering the conductor, through the use of a generally-used extrusion molding machine and the like, with the crosslinked flame-retardant resin composition consistent with the present invention obtained by melting and kneading through the use of a generally-used kneader such as a Banbury mixer, a pressure kneader and a roll, and then cross-linking by radiation, peroxide, or a silane cross-linking agent, and the process is not limited in particular.

On the other hand, the wiring harness consistent with the present invention is prepared by covering a single wire bundle including only the non-halogenous insulated wires or a mixed wire bundle including at least the non-halogenous insulated wires and vinyl chloride insulated wires, with a wiring-harness protective material.

Here, the vinyl chloride insulated wire referred to in the present invention is a wire in which a vinyl chloride resin composition is used as a material for an insulated covering material. Here, a vinyl chloride resin refers to a resin mainly consisting of vinyl chloride monomer, and this resin may be homopolymer of vinyl chloride or copolymer with another monomer. For the vinyl chloride resin, specifically named are polyvinyl chloride, ethylene-vinyl chloride copolymer, propylene-vinyl chloride copolymer, and the like.

Incidentally, descriptions about a constitution of the vinyl chloride insulated wire except for the insulated covering material and a production process of the wire are omitted since they are almost the same as those of the above-described non-halogenous insulated wire.

In addition, the single wire bundle referred to in the present invention is a wire bundle made by tying only the above-described non-halogenous insulated wires into a bundle, while the mixed wire bundle, which includes at least the above-described non-halogenous insulated wires and the vinyl chloride insulated wires, is a wire bundle made by tying these mixed insulated wires into a bundle. At this time, the numbers of the wires included in the single wire bundle and the mixed wire bundle, respectively, may be determined arbitrarily, which are not limited in particular.

In addition, the wiring-harness protective material referred to in the present invention covers the wire bundle made by tying numbers of insulated wires, so as to play a role in protecting the inside wire bundle from an external environment and the like.

In the present invention, preferably utilized as a base material constituting the wiring-harness protective material is a non-halogenous resin composition, a vinyl chloride resin composition, or a halogenous resin composition other than the vinyl chloride resin composition.

Utilized as the non-halogenous resin composition may be a polyolefin flame-retardant resin composition prepared by adding various additives such as a non-halogenous flame retardant to polyolefin such as polyethylene, polypropylene and propylene-ethylene copolymer, the above-described crosslinked flame-retardant resin composition consistent with the present invention, or the like.

In addition, utilized as the vinyl chloride resin composition may be the one described above as the vinyl chloride insulated wire material.

In addition, for the halogenous resin composition other than the vinyl chloride resin composition, named is a composition prepared by adding various additives such as a halogenous flame retardant to the above-described polyolefin, or the like.

Besides, these resin compositions used as the base material may be crosslinked as necessary by a crosslinking agent such as a silane cross-linking agent, electron irradiation or the like.

In addition, for the wiring-harness protective material, one having a tape-shaped base material at least one side of which an adhesive is applied on, one having a base material which is tube-shaped, sheet-shaped or otherwise shaped, or the like may be used while appropriately selected as usage.

Incidentally, owing to the variety of wire bundles and the variety of wiring-harness protective materials as described above, the wiring harness consistent with the present invention includes a variety of wiring harnesses as follows.

Specifically, the wiring harness consistent with the present invention includes one which is made by covering the single wire bundle including only the non-halogenous insulated wires with the vinyl-chloride wiring-harness protective material, one which is made by covering the single wire bundle including only the non-halogenous insulated wires with the non-halogenous wiring-harness protective material, one which is made by covering the single wire bundle including only the non-halogenous insulated wires with the halogenous wiring-harness protective material, one which is made by covering the mixed wire bundle including at least the non-halogenous insulated wires and the vinyl chloride insulated wires with the vinyl-chloride wiring-harness protective material, one which is made by covering the mixed wire bundle including at least the non-halogenous insulated wires and the vinyl chloride insulated wires with the non-halogenous wiring-harness protective material, and one which is made by covering the mixed wire bundle including at least the non-halogenous insulated wires and the vinyl chloride insulated wires with the halogenous wiring-harness protective material.

Next, a detailed description is given to the effect of the non-halogenous insulated wire and the wiring harness consistent with the present invention.

According to the non-halogenous insulated wire consistent with the present invention and the wiring harness consistent with the present invention which includes the non-halogenous insulated wire in the wire bundle, the insulated covering material does not remarkably deteriorate even when the non-halogenous insulated wire is used in contact with (or in proximity to) the vinyl chloride insulated wire in the wire bundle, in contact with (or in proximity to) the vinyl-chloride wiring-harness protective material covering the wire bundle or the halogenous wiring-harness protective material other than the vinyl-chloride wiring-harness protective material, or in contact with (or in proximity to) a rubber stopper, a grommet or the like for water proofing, so that heat resistance is sufficiently delivered over a long period of time.

### EXAMPLE

A description of the present invention will now be given specifically with reference to Examples, however, the present invention is not limited hereto.

(Test Material, Manufacturer, and the Like)

Test materials used in the Examples are given along with manufacturers, trade names, values of physical properties, and the like.

(A) Ingredient:

High density polyethylene <1> (HDPE<1>) [manuf.: Japan Polychem Corporation, trade name: “NOVATEC HD HY331”, MFR =1.0 g/10 min. (JIS K 6760), density=0.950/cm³]; and
Linear low density polyethylene (LLDPE) [manuf.: Nippon Unicar Company Limited, trade name: “DFDJ7540”, MFR=0.8 g/10 min. (JIS K 6760), density=0.930/cm³]
   (B) Ingredient:
   (B1) Ingredient:
High density polyethylene <2> (HDPE<2>) [manuf.: Japan Polychem Corporation, trade name: “NOVATEC HD HJ381”, MFR=11 g/10 min. (JIS K 6760), density=0.950/cm³];
Very low density polyethylene (VLDPE) [manuf.: Dupont Dow Elastomers Japan K.K., trade name: “Engage 8003”, MFR=1.0 g/10 min. (ASTM D-1238), density=0.890/cm³];
Modified high density polyethylene (Modified HDPE) [manuf.: Mitsui Chemicals, Inc., trade name: “ADMER HE040”];
Modified linear low density polyethylene (Modified LLDPE) [manuf.: Mitsui Chemicals, Inc., trade name: “ADMER NF558”];
Modified very low density polyethylene (Modified VLDPE) [manuf.: Mitsui Chemicals, Inc., trade name: “ADMER XE070”];
Ethylene-propylene copolymer (EPM) [manuf.: JSR Corporation, trade name: “EP961SP”]; and
Modified ethylene-propylene copolymer (Modified EPM) [manuf.: JSR Corporation, trade name: “T7741P”]
   (B2) Ingredient:
Ethylene-vinyl acetate copolymer (EVA) [manuf.: Du Pont-Mitsui Polychemicals Co., Ltd., trade name: “EV360”]; and
Modified ethylene-vinyl acetate copolymer (Modified EVA) [manuf.: Du Pont-Mitsui Polychemicals Co., Ltd., trade name: “VR103”]
   (B3) Ingredient:
Ethylene-ethyl acrylate copolymer (EEA) [manuf.: Du Pont-Mitsui Polychemicals Co., Ltd., tradename: “A-714”]
   (B4) Ingredient:
Styrene-ethylene-butylene-styrene block copolymer (SEBS) [manuf.: Asahi Kasei Chemicals Corporation, trade name: “Tuftec H1041”];
Styrene-ethylene-propylene-styrene block copolymer (SEPS) [manuf.: KURARAY CO., LTD., trade name: “SEPTON 2004”]; and
Modified styrene-ethylene-butylene-styrene block copolymer (Modified SEBS) [manuf.: Asahi Kasei Chemicals Corporation, trade name: “Tuftec M1913”]
   (C) Ingredient:
Magnesium hydroxide [manuf.: Martinswerk GmbH, trade name: “MAGNIFIN H10”, average particle size: about 1.0 μm]
   (D) Ingredient:
Zinc sulfide <1> [manuf.: Wako Pure Chemical Industries, Ltd., trade name: “Zinc sulfide”]; and
Zinc sulfide <2> [manuf.: Sachtleben Chemie GmbH, trade name: “Sachtolith HD”]
   (E) Ingredient:
Acryl silane coupling agent [manuf.: GE Toshiba Silicones, trade name: “TSL8370”]; and
Vinyl silane coupling agent [manuf.: Shin-Etsu Chemical Co., Ltd., trade name: “KBM 1003”]
   Other ingredients:
Phenolic antioxidant [manuf.: Ciba Specialty Chemicals Inc., trade name: “Irganox 1010”];
Sulfurous antioxidant [manuf.: SHIPRO KASEI KAISHA, LTD., trade name: “SEENOX 412S”];
Phosphorous antioxidant [manuf.: Ciba Specialty Chemicals Inc., trade name: “Irgafos 168”];
Metal deactivator [manuf.: Asahi Denka Co., Ltd., trade name: “CDA-1”]; and
Cross-linking auxiliary agent [manuf.: SHIN-NAKAMURA CHEMICAL CO., LTD., trade name: “TMPTMA”]
   Comparative Ingredients:
High density polyethylene <2> (HDPE<2>) [manuf.: Japan Polychem Corporation, trade name: “NOVATEC HD HJ381”, MFR=11 g/10 min. (JIS K 6760), density=0.950/cm³];
Polypropylene [manuf.: Japan Polychem Corporation, trade name: “NOVATEC EC9”, MFR=0.5 g/10 min. (JIS K 6758), density=0.90/cm³];
Zinc oxide [manuf.: Hakusui Tech Co., Ltd., trade name: “Zinc Oxide JIS2”,];
Zinc acrylate [manuf.: Kawaguchi Chemical Industry Co,. LTD., trade name: “Actor ZA”]; and
Zinc borate [manuf.: BORAX INC., trade name: “Firebrake ZB”,]

Besides, the above-mentioned high density polyethylene <2> (HDPE<2>) is a comparative ingredient in view of the (A) ingredient while falls under the (B1) ingredient in view of the (B) ingredient.

(Preparation of Composition and Insulated Wire)

Firstly, by blending the respective ingredients presented in Tables shown later at a mixing temperature of 250° C. through the use of a twin-screw kneader and pelletizing them through the use of a pelletizing machine, compositions consistent with the Examples and compositions consistent with Comparative Examples were obtained. Subsequently, the obtained compositions were dried, and then extrusion covered on conductors (cross sectional area: 0.5 mm²), which were soft-copper twisted wires made by twisting seven soft copper wires together, to have a thickness of 0.3 mm through the use of an extrusion molding machine. Then, an electron beam was irradiated onto the respective obtained insulated wires to cross-link insulated covering materials so as to prepare non-halogenous insulated wires consistent with the Examples and non-halogenous insulated wires consistent with the Comparative Examples. The irradiation dose of the electron beam was set to be 8 Mrad. Besides, the irradiation of the electron beam was not performed on the Comparative Examples 19 and 20.

[Test Procedure]

The respective insulated wires prepared as above were subjected to a flame-retardancy test, a wear-resistance test, a flexibility test, a workability test, and a compatibility test. Hereinafter, descriptions will be given to respective test procedures and respective assessment procedures.

(Flame-Retardancy Test)

The flame-retardancy test was performed based on JASO D611. To be more specific, the non-halogenous insulated wires consistent with the Examples and the non-halogenous insulated wires consistent with the Comparative Examples were cut into test specimens 300 mm long, each of which was placed in an iron test box to be held horizontal, and the tip of a reducing flame by a Bunsen burner having a caliber of 10 mm was placed beneath the center of the test specimen within 30 seconds until it burned, and then, after the flame was calmly removed, an afterflame time of the test specimen was measured. The test specimen whose afterflame time was within 15 seconds was regarded as passed, and the one whose afterflame time was over 15 seconds was regarded as failed.

(Wear-Resistance Test)

The wear-resistance test was performed by a blade-reciprocating method based on JASO D611. To be more specific, the non-halogenous insulated wires consistent with the Examples and the non-halogenous insulated wires consistent with the Comparative Examples were cut into test specimens 750 mm long, and then at a room temperature of 25° C., a blade was made to reciprocate in a direction of its shaft over a length of 10 mm on a surface of the insulated covering material of each test specimen which was fixed to a table, and the number of reciprocation before the blade touches the conductor due to the wearing away of the insulated covering material was counted. At this time, a load imposed on the blade was set at 7N, and the blade was set to reciprocate at a speed of 50 times/minute. Then, the test specimen was moved by 100 mm and rotated 90 degrees clockwise, and the measurement as described above was repeated. The measurement was performed three times in total with respect to one test specimen, and the one whose smallest reciprocation number was 150 or more was regarded as passed, and the one whose smallest reciprocation number was below 150 was regarded as failed.

(Flexibility Test)

The flexibility test was performed by assessing the non-halogenous insulated wires consistent with the Examples and the non-halogenous insulated wires consistent with the Comparative Examples by the touch when bending by hands. To be more specific, the one which had a good feel was regarded as passed and the one which had an unfavorable feel was regarded as failed.

(Workability Test)

The workability test was performed by checking whether fringes were formed or not when resin-covered parts at the ends of the non-halogenous insulated wires consistent with the Examples and the non-halogenous insulated wires consistent with the Comparative Examples were stripped off, and the one which did not form a fringe was regarded as passed and the one which formed a fringe was regarded as failed.

(Compatibility Test)

Tests under conditions A and B below were performed, and the one which passed both the tests was regarded as passed the compatibility test.

<Condition A>

Mixed wire bundles were prepared by randomly tying ten pieces of polyvinyl chloride (PVC) wires made by extrusion covering conductors with PVC as an insulated covering material and three pieces of the non-halogenous insulated wires consistent with the Examples or the non-halogenous insulated wires consistent with the Comparative Examples into a bundle. Then, each mixed wire bundle was covered with a PVC sheet as a wiring-harness protective material, and then at the end of the PVC sheet, a PVC tape was wound fivefold as a wiring-harness protective material to prepare a wiring harness. Then, this wiring harness was subjected to aging at 130° C. for 480 hours, and then the three pieces of the non-halogenous insulated wires consistent with the Examples and the non-halogenous insulated wires consistent with the Comparative Examples were taken out from the mixed wire bundle and coiled to its own diameter. The one in which none of the three pieces cracked was regarded as passed and the one in which any one of the three pieces cracked was regarded as failed.

<Condition B>

Mixed wire bundles were prepared by randomly tying three pieces of PVC wires and ten pieces of the non-halogenous insulated wires consistent with the Examples and the non-halogenous insulated wires consistent with the Comparative Examples into a bundle. Then, each mixed wire bundle was covered with a PVC sheet as a wiring-harness protective material, and then at the end of the PVC sheet, a PVC tape was wound fivefold as a wiring-harness protective material to prepare a wiring harness. Then, this wiring harness was subjected to aging at 130° C. for 480 hours, and then the ten pieces of the non-halogenous insulated wires consistent with the Examples and the non-halogenous insulated wires consistent with the Comparative Examples were taken out from the mixed wire bundle and coiled to its own diameter. The one in which none of the ten pieces cracked was regarded as passed and the one in which any one of the ten pieces cracked was regarded as failed.

Ingredient constitution and assessment results of the compositions are shown in the following Tables 1-4.

TABLE 1

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| (A) ingredient | | | | | | | | | | |
| HDPE<1> | 30 | 50 | 30 | 50 | 40 | 50 | 60 | 50 | 70 | 60 |
| LLDPE | | | 20 | | 50 | | | | | |
| (B) ingredient | | | | | | | | | | |
| (B1) HDPE<2> | | | | | | | | | | |
| VLDPE | | 20 | | | | | | | | |
| Modified HDPE | | | | | | | | | | |
| Modified LLDPE | 30 | | | | | | | | | |
| Modified VLDPE | | | | | 10 | | | | | |
| EPM | | | | | | | | | | |
| Modified EPM | | | 30 | | | | | | | 20 |
| (B2) EVA | 40 | | | | | 50 | 40 | 20 | | |
| Modified EVA | | 30 | | | | | | 30 | | |
| (B3) EEA | | | | 30 | | | | | | |
| (B4) SEBS | | | 20 | | | | | | | |
| SEPS | | | | | | | | | | 20 |
| Modified SEBS | | | | 20 | | | | | 30 | |
| (C) ingredient | | | | | | | | | | |
| Magnesium hydroxide | 30 | 250 | 90 | 100 | 40 | 90 | 120 | 80 | 90 | 150 |
| (D) ingredient | | | | | | | | | | |
| Zinc sulfide<1> | 3 | | 20 | 1 | 3 | 5 | 6 | 5 | 4 | 5 |
| Zinc sulfide<2> | | 5 | | | | | | 5 | | |
| (E) ingredient | | | | | | | | | | |
| Acryl silane | | | | | | 0.3 | 10 | | 2 | |
| coupling agent | | | | | | | | | | |
| Vinyl silane | | | | | | | | 3 | | |
| coupling agent | | | | | | | | | | |
| Other ingredients | | | | | | | | | | |
| Phenolic antioxidant | 3 | 4 | 3 | 5 | 4 | 2 | 4 | 3 | 2 | 3 |
| Sulfurous antioxidant | 1 | 1 | 2 | 2 | | 1 | 1 | 1 | 0.5 | 1 |
| Phosphorous antioxidant | | 0.5 | | 1 | | 0.5 | | 0.5 | 1 | |
| Metal deactivator | 1 | 1 | 0.5 | 1 | 1 | 1 | 0.5 | 1 | 1 | 0.5 |
| Cross-linking | 2 | 4 | 2 | 4 | 4 | 3 | 2 | 2 | 4 | 4 |
| auxiliary agent | | | | | | | | | | |
| Total | 140 | 365.5 | 217.5 | 214 | 152 | 202.8 | 243.5 | 200.5 | 204.5 | 263.5 |
| Flame retardancy | passed | passed | passed | passed | passed | passed | passed | passed | passed | passed |
| Wear resistance | 233 | 328 | 227 | 290 | 218 | 292 | 393 | 325 | 606 | 221 |
| (number of times) | | | | | | | | | | |
| Flexibility | passed | passed | passed | passed | passed | passed | passed | passed | passed | passed |
| Workability | passed | passed | passed | passed | passed | passed | passed | passed | passed | passed |
| Compatibility: | | | | | | | | | | |
| Condition A | passed | passed | passed | passed | passed | passed | passed | passed | passed | passed |
| Condition B | passed | passed | passed | passed | passed | passed | passed | passed | passed | passed |

TABLE 2

| | Example | Example | Example | Example | Example | Example | Example | Example | Example | Example |
|---|---|---|---|---|---|---|---|---|---|---|
| | 11 | 12 | 13 | 14 | 15 | 16 | 17 | 18 | 19 | 20 |
| (A) ingredient | | | | | | | | | | |
| HDPE<1> | 60 | 50 | 30 | | 60 | 60 | 60 | 30 | 30 | 90 |
| LLDPE | | 20 | | 70 | | | | | | |
| (B) ingredient | | | | | | | | | | |
| (B1) HDPE<2> | | | | | | | | | 20 | |
| VLDPE | | | | | | | | | | |
| Modified HDPE | | | 20 | | | | | 20 | | |
| Modified LLDPE | | | | | | | | | | |
| Modified VLDPE | | 30 | | | | | | | | |
| EPM | 30 | | | | | | | | | |
| Modified EPM | | | | | | | | | | |
| (B2) EVA | | | | | | | | | | |
| Modified EVA | | | 30 | | 20 | | 20 | 30 | | |
| (B3) EEA | | | | 30 | | 20 | 10 | | 30 | |
| (B4) SEBS | | | | | | | | 20 | | |
| SEPS | | | | | | | | | | |
| Modified SEBS | 10 | | 20 | | 20 | 20 | 10 | | 20 | 10 |
| (C) ingredient | | | | | | | | | | |
| Magnesium hydroxide | 100 | 70 | 70 | 90 | 100 | 100 | 70 | 100 | 90 | 90 |
| (D) ingredient | | | | | | | | | | |
| Zinc sulfide<1> | | 3 | 15 | 4 | 5 | 5 | 5 | | 5 | 5 |
| Zinc sulfide<2> | 5 | | | | | | | 3 | | |
| (E) ingredient | | | | | | | | | | |
| Acryl silane | | | | 2 | | | | | | |
| coupling agent | | | | | | | | | | |
| Vinyl silane | | | | | | | | | | |
| coupling agent | | | | | | | | | | |
| Other ingredients | | | | | | | | | | |
| Phenolic antioxidant | 4 | 3 | 3 | 3 | 2 | 2 | 2 | 3 | 3 | 4 |
| Sulfurous antioxidant | 1 | 2 | 1 | 1 | 0.5 | 0.5 | 0.5 | 1 | 1 | 1 |
| Phosphorous antioxidant | | 0.5 | | | | | | | | |
| Metal deactivator | 1 | 0.5 | 1 | 1 | 0.5 | 0.5 | 0.5 | 1 | 1 | 1 |
| Cross-linking | 4 | 2 | | 4 | 2 | 2 | 2 | 3 | 4 | 4 |
| auxiliary agent | | | | | | | | | | |
| Total | 215 | 181 | 190 | 205 | 210 | 210 | 180 | 211 | 204 | 205 |
| Flame retardancy | passed | passed | passed | passed | passed | passed | passed | passed | passed | passed |
| Wear resistance | 213 | 426 | 293 | 185 | 383 | 430 | 338 | 380 | 267 | 521 |
| (number of times) | | | | | | | | | | |
| Flexibility | passed | passed | passed | passed | passed | passed | passed | passed | passed | passed |
| Workability | passed | passed | passed | passed | passed | passed | passed | passed | passed | passed |
| Compatibility: | | | | | | | | | | |
| Condition A | passed | passed | passed | passed | passed | passed | passed | passed | passed | passed |
| Condition B | passed | passed | passed | passed | passed | passed | passed | passed | passed | passed |

TABLE 3

| | Comparative | Comparative | Comparative | Comparative | Comparative | Comparative |
|---|---|---|---|---|---|---|
| | example 1 | example 2 | example 3 | example 4 | example 5 | example 6 |
| (A) ingredient | | | | | | |
| HDPE<1> | | 95 | 50 | 70 | 30 | 40 |
| LLDPE | 20 | | | | | |
| HDPE<2> (※) | | | | | | |
| PP (※) | | | | | | |
| (B) ingredient | | | | | | |
| (B1) Modified VLDPE | 30 | | | | | |
| Modified EPM | | | | | | |
| (B2) EVA | 50 | | | | 70 | 60 |
| Modified EVA | | | 20 | | | |
| (B3) EEA | | | 30 | 10 | | |
| (B4) SEBS | | | | | | |
| Modified SEBS | | 5 | | 20 | | |
| (C) ingredient | | | | | | |
| Magnesium hydroxide | 50 | 100 | 20 | 270 | 50 | 90 |
| (D) ingredient | | | | | | |
| Zinc sulfide<1> | 5 | 5 | 5 | 3 | 3 | 5 |
| Zinc oxide (※) | | | | | | |
| Zinc acrylate (※) | | | | | | |
| Zinc borate (※) | | | | | | |
| (E) ingredient | | | | | | |
| Acryl silane | | | | | | 0.1 |
| coupling agent | | | | | | |
| Other ingredients | | | | | | |
| Phenolic antioxidant | 3 | 4 | 3 | 3 | 3 | 2 |
| Sulfurous antioxidant | 1 | | 2 | 2 | 1 | 1 |
| Phosphorous antioxidant | | | | 0.5 | | |
| Metal deactivator | 1 | 1 | 0.5 | 1 | 1 | 1 |
| Cross-linking | 4 | 4 | 2 | 4 | 4 | 4 |
| auxiliary agent | | | | | | |
| Total | 164 | 214 | 132.5 | 383.5 | 162 | 203.1 |
| Flame retardancy | passed | passed | failed | passed | passed | passed |
| Wear resistance | 42 | 550 | 168 | 320 | 98 | 116 |
| (number of times) | | | | | | |
| Flexibility | passed | failed | passed | failed | passed | passed |
| Workability | passed | failed | passed | failed | passed | passed |
| Compatibility: | | | | | | |
| Condition A | passed | passed | passed | passed | passed | passed |
| Condition B | passed | passed | passed | passed | passed | passed |

| | Comparative | Comparative | Comparative | Comparative | Comparative |
|---|---|---|---|---|---|
| | example 7 | example 8 | example 9 | example 10 | example 11 |
| (A) ingredient | | | | | |
| HDPE<1> | 50 | 50 | 60 | 60 | 70 |
| LLDPE | | | | | |
| HDPE<2> (※) | | | | | |
| PP (※) | | | | | |
| (B) ingredient | | | | | |
| (B1) Modified VLDPE | 20 | | | | |
| Modified EPM | | | | | |
| (B2) EVA | 30 | 20 | | 20 | |
| Modified EVA | | 30 | | 30 | 20 |
| (B3) EEA | | | 20 | | |
| (B4) SEBS | | | | | 10 |
| Modified SEBS | | | 20 | | |
| (C) ingredient | | | | | |
| Magnesium hydroxide | 120 | 80 | 100 | 100 | 130 |
| (D) ingredient | | | | | |
| Zinc sulfide<1> | 4 | | | | 0.5 |
| Zinc oxide (※) | | | | | |
| Zinc acrylate (※) | | | | | |
| Zinc borate (※) | | | | | |
| (E) ingredient | | | | | |
| Acryl silane | 15 | 3 | | | |
| coupling agent | | | | | |
| Other ingredients | | | | | |
| Phenolic antioxidant | 4 | 3 | 8 | 6 | 3 |
| Sulfurous antioxidant | 1 | 1 | 2 | 6 | 1 |
| Phosphorous antioxidant | | 0.5 | 1 | | |
| Metal deactivator | 0.5 | 1 | 2 | 1 | 0.5 |
| Cross-linking | 3 | 2 | 4 | 2 | 4 |
| auxiliary agent | | | | | |
| Total | 247.5 | 190.5 | 217 | 225 | 239 |
| Flame retardancy | passed | passed | passed | passed | passed |
| Wear resistance | 328 | 306 | 328 | 375 | 592 |
| (number of times) | | | | | |
| Flexibility | passed | passed | passed | passed | passed |
| Workability | failed | passed | passed | passed | passed |
| Compatibility: | | | | | |
| Condition A | passed | failed | failed | failed | failed |
| Condition B | passed | failed | failed | failed | failed |

NOTE:
An ingredient with an asterisk is a comparative ingredient.

TABLE 4

| | Comparative | Comparative | Comparative | Comparative | Comparative | Comparative |
|---|---|---|---|---|---|---|
| | example 12 | example 13 | example 14 | example 15 | example 16 | example 17 |
| (A) ingredient | | | | | | |
| HDPE<1> | 20 | 60 | 50 | 50 | 50 | 50 |
| LLDPE | 40 | | 20 | | | |
| HDPE<2> (※) | | | | | | |
| PP (※) | | | | | | |
| (B) ingredient | | | | | | |
| (B1) Modified VLDPE | 20 | | | | | |
| Modified EPM | | | | | | |
| (B2) EVA | 20 | 40 | | 30 | 30 | 30 |
| Modified EVA | | | 30 | 20 | 20 | 20 |
| (B3) EEA | | | | | | |
| (B4) SEBS | | | | | | |
| Modified SEBS | | | | | | |
| (C) ingredient | | | | | | |
| Magnesium hydroxide | 100 | 90 | 90 | 90 | 90 | 90 |
| (D) ingredient | | | | | | |
| Zinc sulfide<1> | 25 | | | | | |
| Zinc oxide (※) | | | | 5 | | |
| Zinc acrylate (※) | | | | | 5 | |
| Zinc borate (※) | | | | | | 5 |
| (E) ingredient | | | | | | |
| Acryl silane | | 2 | | | | |
| coupling agent | | | | | | |
| Other ingredients | | | | | | |
| Phenolic antioxidant | 4 | 3 | 4 | 3 | 3 | 3 |
| Sulfurous antioxidant | 1 | 1 | 2 | 1 | 1 | 1 |
| Phosphorous antioxidant | | | 0.5 | | | |
| Metal deactivator | 1 | 1 | 1 | 1 | 1 | 1 |
| Cross-linking | 4 | 2 | 4 | 4 | 4 | 4 |
| auxiliary agent | | | | | | |
| Total | 235 | 199 | 201.5 | 204 | 204 | 204 |
| Flame retardancy | passed | passed | passed | passed | passed | passed |
| Wear resistance | 73 | 421 | 336 | 260 | 331 | 224 |
| (number of times) | | | | | | |
| Flexibility | passed | passed | passed | passed | passed | passed |
| Workability | passed | passed | passed | passed | passed | passed |
| Compatibility: | | | | | | |
| Condition A | passed | failed | failed | failed | failed | failed |
| Condition B | passed | failed | failed | failed | failed | failed |

| | Comparative | Comparative | Comparative | Comparative | Comparative |
|---|---|---|---|---|---|
| | example 18 | example 19 | example 20 | example 21 | example 22 |
| (A) ingredient | | | | | |
| HDPE<1> | | | | | |
| LLDPE | | | | | |
| HDPE<2> (※) | 80 | | | | |
| PP (※) | | 60 | 60 | 60 | 60 |
| (B) ingredient | | | | | |
| (B1) Modified VLDPE | | | | | |
| Modified EPM | | | | | |
| (B2) EVA | | 20 | 20 | 20 | 20 |
| Modified EVA | | | | | |
| (B3) EEA | | | | | |
| (B4) SEBS | | | | | |
| Modified SEBS | 20 | 20 | 20 | 20 | 20 |
| (C) ingredient | | | | | |
| Magnesium hydroxide | 70 | 90 | 90 | 90 | 90 |
| (D) ingredient | | | | | |
| Zinc sulfide<1> | 5 | | | 5 | 5 |
| Zinc oxide (※) | | | | | |
| Zinc acrylate (※) | | | | | |
| Zinc borate (※) | | | | | |
| (E) ingredient | | | | | |
| Acryl silane | | | | | |
| coupling agent | | | | | |
| Other ingredients | | | | | |
| Phenolic antioxidant | 3 | 4 | 4 | 4 | 4 |
| Sulfurous antioxidant | 1 | | | | |
| Phosphorous antioxidant | | | | | |
| Metal deactivator | 1 | 1 | 1 | 1 | 1 |
| Cross-linking | 3 | | 4 | | 4 |
| auxiliary agent | | | | | |
| Total | 183 | 195 | 199 | 200 | 204 |
| Flame retardancy | passed | passed | passed | passed | passed |
| Wear resistance | 483 | 420 | 441 | 382 | 442 |
| (number of times) | | | | | |
| Flexibility | passed | passed | passed | passed | passed |
| Workability | passed | passed | passed | passed | passed |
| Compatibility: | | | | | |
| Condition A | failed | failed | failed | failed | failed |
| Condition B | passed | failed | failed | failed | failed |

NOTE:
An ingredient with an asterisk is a comparative ingredient.

According to Tables 3 and 4 given above, the crosslinked flame-retardant resin compositions, the non-halogenous wires and the wiring harnesses consistent with the Comparative Examples are turned out to have a drawback in any item of the assessment items: flame retardancy, wear resistance, flexibility, workability, and compatibility.

To be more specific, the Comparative Examples 1 and 2, in which the polyethylene of which the melt flow rate (MFR) is 5 g/10 min. or less and the density is 0.90 g/cm³ or more as the (A) ingredient is not contained by the specific amount, is degraded in wear resistance, flexibility or workability.

In addition, the Comparative Examples 3 and 4, in which the metallic hydrate as the (C) ingredient is not contained by the specific amount, is degraded in flame retardancy, flexibility or workability.

In addition, the Comparative Example 5, in which the polymer as the (B) ingredient is not modified by acid and neither the organo-functional coupling agent as the (E) ingredient is contained, is insufficient in wear resistance.

In addition, the Comparative Example 6, in which the organo-functional coupling agent as the (E) ingredient is contained but its blending amount is less than the specific amount, does not improve in wear resistance.

In addition, the Comparative Example 7, in which the organo-functional coupling agent as the (E) ingredient is contained but its blending amount is more than the specific amount, gives rise to bleeding of the coupling agent and the like to decrease in workability.

In addition, the Comparative Examples 8 to 11, 13 and 14, in which the zinc compound as the (D) ingredient is not contained at all or is not contained by the specific amount, do not satisfy compatibility.

In addition, the Comparative Example 12, in which the zinc compound as the (D) ingredient is contained but its blending amount is more than the specific amount, is degraded in wear resistance and the like.

In addition, the Comparative Example 15 to 17, in which a proper zinc compound is not employed as the (D) ingredient, does not satisfy compatibility.

In addition, the Comparative Example 18, in which the polyethylene of which the melt flow rate (MFR) is 5 g/10 min. or less and the density is 0.90 g/cm³ or more is not employed as the (A) ingredient., does not satisfy compatibility.

In addition, the Comparative Examples 19 to 22, in which polypropylene is used as the (A) ingredient instead of using the polyethylene of which the melt flow rate (MFR) is 5 g/10 min. or less and the density is 0.90 g/cm³ or more, does not satisfy compatibility even if the zinc compound is added thereto as the (D) ingredient.

According to Tables 1 and 2 given above, in contrast to the Comparative Examples, it was shown that the crosslinked flame-retardant resin compositions, the non-halogenous wires, and the wiring harnesses consistent with the Examples are excellent in all of flame retardancy, wear resistance, flexibility, workability, and compatibility.

1. A crosslinked flame-retardant resin composition comprising:
100 part weight of a resin ingredient containing:
(A) polyethylene of which a melt flow rate (MFR) is 5 g/10 min. or less and density is 0.90 g/cm³ or more; and
(B) at least one polymer selected from:
(B 1) alpha-olefin (co)polymer;
(B2) ethylene-vinylester copolymer;
(B3) ethylene-alpha, beta-unsaturated carboxylic acid alkyl ester copolymer; and
(B4) a styrene thermoplastic elastomer;
30-250 part weight of (C) metallic hydrate; and
1-20 part weight of (D) a zinc compound,
wherein, in the resin ingredient, the content of (A) the polyethylene is 30-90 wt % and the content of (B) the polymer is 70-10 wt %, and
one or both of a condition that at least one of (B) the polymer is modified by acid and a condition that 0.3-10 part weight of (E) an organo-functional coupling agent is further contained are met.

2. The crosslinked flame-retardant resin composition according to claim 1, wherein (D) the zinc compound is zinc sulfide.

3. ) A non-halogenous insulated wire comprising a conductor covered with the crosslinked flame-retardant resin composition according to claim 1.

4. The non-halogenous insulated wire according to claim 3, being crosslinked by one of radiation, peroxide and a silane cross-linking agent.

5. A wiring harness comprising:
one of a single wire bundle including only the non-halogenous insulated wires according to claim 3, and a mixed wire bundle including at least the non-halogenous insulated wires according to claim 3 and vinyl chloride insulated wires; and
a wiring-harness protective material for covering the wire bundle, in which one of a non-halogenous resin composition, a vinyl chloride resin composition, and a halogenous resin composition other than the vinyl chloride resin composition is used as a base material.

6. A non-halogenous insulated wire comprising a conductor covered with the crosslinked flame-retardant resin composition according to claim 2.

7. The non-halogenous insulated wire according to claim 6, being crosslinked by one of radiation, peroxide and a silane cross-linking agent.

8. A wiring harness comprising:
one of a single wire bundle including only the non-halogenous insulated wires according to claim 4, and a mixed wire bundle including at least the non-halogenous insulated wires according to claim 4 and vinyl chloride insulated wires; and
a wiring-harness protective material for covering the wire bundle, in which one of a non-halogenous resin composition, a vinyl chloride resin composition, and a halogenous resin composition other than the vinyl chloride resin composition is used as a base material.

9. A wiring harness comprising:
one of a single wire bundle including only the non-halogenous insulated wires according to claim 6, and a mixed wire bundle including at least the non-halogenous insulated wires according to claim 6 and vinyl chloride insulated wires; and
a wiring-harness protective material for covering the wire bundle, in which one of a non-halogenous resin composition, a vinyl chloride resin composition, and a halogenous resin composition other than the vinyl chloride resin composition is used as a base material.
